(19) United States
(12) Patent Application Publication
(10) Pub. No.: US 2021/0216679 A1
(43) Pub. Date: Jul. 15, 2021

(54) COLLABORATION INTERFACE FOR FACILITATING THE EXCHANGE OF DATA BETWEEN AN MCAD TOOL AND AN ECAD TOOL

(71) Applicant: EMA Design Automation, Inc., Rochester, NY (US)

(72) Inventor: Jeffrey Eugene Imes, Emmitsburg, MD (US)

(21) Appl. No.: 17/145,237

(22) Filed: Jan. 8, 2021

Related U.S. Application Data
(60) Provisional application No. 62/959,730, filed on Jan. 10, 2020.

(51) Int. Cl. G06F 30/17; G06F 30/20

(52) U.S. Cl. CPC G06F 30/17; G06F 30/20

(57) ABSTRACT

The present method may be performed by a collaboration interface of the present disclosure. The method receives a design file from a first design tool, modifies the design file into a format file used by the first design tool and a second design tool, and transmits the format file to the second design tool. Alternatively, the method receives a design file in a first native format from a first design tool, modifies via a collaboration interface the design file by embedding baseline data to create a collaboration file, and presents the collaboration file to a second design tool operating in a second native format.

This application claims priority under 35 U.S.C. § 119(e) to U.S. provisional patent application Ser. No. 62/959,730, filed on Jan. 10, 2020, which is hereby incorporated by reference in its entirety.

The present disclosure relates generally to converging electrical and mechanical portions of a design in the product development process. More specifically the present disclosure pertains to a collaboration tool that utilizes an ECAD (electronic computer-aided design) software to design and create electronic structures and an MCAD (mechanical computer-aided design) software to design and create mechanical systems.

### BACKGROUND

In order to design intelligent products that integrate electrical and mechanical characteristics, the design and engineering should also be integrated. ECAD and MCAD should work together to enable true interoperability.

Almost every PCB (printed circuit board) built is intended to fit in a case and/or enclosure at some point. The design of the PCB board and its case/enclosure are interdependent and careful consideration should be taken to ensure everything will be in working order when the product is ultimately brought to market. This balance between what the PCB needs workflows to ‘do’ and how it ‘fits’ in the physical world is not to be taken lightly. Many designs have been derailed by conflicts between ECAD and MCAD. Something as simple as an improperly placed and/or communicated mounting hole can send a project into a tailspin of re-designs. Traditionally, collaboration between ECAD and MCAD teams has been more of a ‘throw it over the wall’ approach, which typically means poor communication and can lead to inefficiencies on both sides.

### SUMMARY

There is provided an automation design tool which includes a first design tool for designing and creating structures in a first predefined design environment. There is provided a storage medium for storing and receiving data files having a predefine format, the data files being representative of a structure created in a second predefined design environment. Furthermore there is provided a collaboration interface, operatively connected to the first design tool and the storage medium, wherein the collaboration interface generates collaborative data files having a collaborative data format derived from the data files being representative of the structure, wherein when the structure is modified in the first predefined design environment, the collaborative interface automatically captures data needed for specific changes and requirements in the second predefined design environment.

In one embodiment of the present disclosure, there is provided a collaboration interface which includes a storage medium for storing and receiving one or more data files being representative of a structure created in a second predefined design environment, the one or more data files having a first predefined data format. There is provided a processor unit, operatively connected to the storage medium and a first design tool for designing and creating structures in a first predefined design environment, the processor unit generates collaborative data files having a collaborative data format derived from the one or more data files being representative of the structure, wherein when the structure is modified in the first predefined design environment, the processor unit automatically captures data needed for specific changes and requirements in the second predefined design environment.

In another embodiment of the present disclosure, there is provided a collaboration method for designing and creating electronic structures and mechanical systems in a first predefined design environment and a second predefined design environment. The method includes receiving one or more data files being representative of the structure created in the second predefined design environment, the one or more data files having a first predefined data format; generating a collaborative data file having a collaborative data format derived from the one or more data files being representative of the structure; and automatically capturing data needed for specific changes and requirements in the second predefined design environment when the structure is modified in the first predefined design environment.

In another embodiment, the method receives a design file in a first native format from a first design tool, modifies via a collaboration interface the design file by embedding baseline data to create a collaboration file, and presents the collaboration file to a second design tool operating in a second native format.

With the above and other aspects in view, which will appear as the description proceeds, the disclosure in the novel construction, combination and arrangement of parts substantially as hereinafter described and more particularly defined in the appended claims, it being understood that such changes in the precise embodiment of the herein disclosed disclosure may be made as come within the scope of the claims.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 is a schematic illustration of an MCAD tool, ECAD tool and collaboration interface according to one embodiment of the present disclosure;

FIGS. 2 and 2a illustrate screenshots of example feature windows in accordance with one embodiment of the present disclosure;

FIG. 3 illustrates an example screenshot of an assembly created by a PCB export in an MCAD tool in accordance with one embodiment of the present disclosure;

FIG. 4 illustrates an example screenshot of a board outline of the assembly of FIG. 3 created by a PCB export in an MCAD tool in accordance with one embodiment of the present disclosure;

FIGS. 5A and 5B. illustrate example flowcharts on how to write/read data into MCAD tool and ECAD tool in accordance with one embodiment of the present disclosure;

FIG. 6 illustrates an example flowchart for initializing a design from an MCAD tool in accordance with one embodiment of the present disclosure;

FIG. 7 illustrates an example flowchart for initializing a design from an ECAD tool in accordance with one embodiment of the present disclosure;

FIG. 8 illustrates an example flowchart for invoking a design change from the ECAD tool in the collaboration flow accordance with one embodiment of the present disclosure;

FIG. 9 illustrates an example flowchart for invoking a design change from the MCAD tool in the collaboration flow in accordance with one embodiment of the present disclosure; and

FIG. 10 illustrates a flowchart showing an example of a collaboration method for designing and creating electronic structures and mechanical systems in a first predefined design environment and a second predefined design environment according to various embodiments of the present disclosure.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Furthermore, the present embodiments encompass present and future known equivalents to the known components referred to herein by way of illustration.

Embodiments of the present disclosure provide an automation design system that includes a collaboration interface between the MCAD tool and the ECAD tool. The collaboration interface includes a PCB Tools utility which allows the user to start a design intuitively and add ECAD based features easily in MCAD tools such as components, cut-outs, mounting holes, keepin/outs, and copper areas). Designers can automatically create native MCAD parts from STEP (Standard for the Exchange of Product model data) Models associated in ECAD tool. Furthermore, the collaboration interface can create composite collaboration data files including STEP files automatically from the ECAD tool to be directly imported into the MCAD tool. Since the collaboration interface allows the ECAD tool's PCB data to be communicated to the MCAD tool using native solid parts, features, and assemblies, MCAD designers can also easily simulate and analyze PCB elements in the context of the mechanical assembly (e.g., an MCAD generated assembly design). Furthermore, the collaborative interface automatically captures data needed to revise the collaborative data files to properly specify modification changes and requirements of the MCAD tool design environment or ECAD tool design environment, if there is a design change made in either the MCAD tool design environment or ECAD tool design environment. An advantageous feature of the automation design system of the present disclosure is that the collaboration interface enables a connection between ECAD and MCAD domains without the need for any middleware.

In one embodiment, the automation design system of the present disclosure comprises one or more workstations and software running thereupon. Each workstation comprises at least a computer or a processor, a memory, a display system, and input devices including a keyboard and a mouse or other pointing devices. Typically, there may also be one or more mass storage mediums such as a disk drive and cloud storage available for program and data storage and retrieval. If more than one workstation is used, then they may be connected by a communication interface which may be a network, a simple communication line, or shared memory.

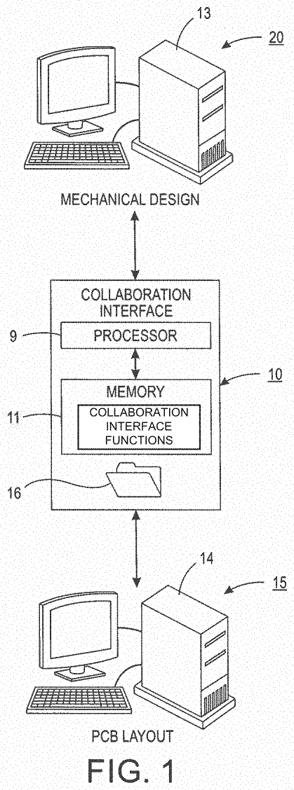

Now turning to FIG. 1 a schematic illustration of an MCAD tool, an ECAD tool and a collaboration interface according to one embodiment of the present disclosure is presented. The arrangement may comprise one or more devices, such as a personal computer and/or a server, running a computer program in a memory in accordance with the present disclosure for executing computational operations, such as mapping between the locations of original (e.g., substantially flat/2D) substrate and 3D formed version thereof, and providing a visual user interface (UI) via a local or remote digital display. Collaboration interface 10 may include a processor unit 9 which can perform various functions, for example of capturing data and the facilitating of the exchange of data between the ECAD tool and the MCAD tool. The processing unit 9 may be any type of programmable electronic device for executing software instructions but will conventionally be a microprocessor. The system memory may include both a read-only memory (ROM) and a random-access memory (RAM). As will be appreciated by those of ordinary skill in the art, both the read-only memory (ROM) and the random-access memory (RAM) may store software instructions for execution by the processing unit 9. The processing unit 9 is connected, either directly or indirectly, to a mass storage medium 11.

The present embodiment can utilize a first design tool such as an MCAD tool 20 and a second design tool such as an ECAD tool 15. For example, an ECAD tool 15 is installed on personal computer 14 and an MCAD tool 20 is installed on personal computer 13. For example, desirable off-the-shelf tools that can be utilized by the present disclosure are OrCAD/Allegro® ECAD tools from the Cadence® company and Solidworks® MCAD tools from the Dassault Systemes company. Collaboration interface 10 may include two components. For example, the collaboration interface 10 may include a collaboration PCB software plug-in installed on ECAD tool 15 and a collaboration MCAD software plug-in installed on MCAD tool 20. Thus, although the collaboration interface 10 is illustrated in one embodiment in FIG. 1 as a distinct system from the first design tool such as the MCAD tool 20 and the second design tool such as the ECAD tool 15, the collaboration interface 10 can be implemented as a part of the first design tool such as the MCAD tool 20 and/or a part of the second design tool such as the ECAD tool 15. Once installed collaboration menu and dialog boxes items are added to the UI of MCAD tool 20 and the UI of ECAD tool 15. The exchange of data may be accomplished by the two components through a user defined collaboration folder 16 which may include one or more mass storage mediums 11. Storage medium 11 stores and receives one or more data files (for example data files may include STEP files, PCB files and Parts component files) which are representative of a structure (for example, an assembly, a PCB board outline, and a Parts component). The structure can be created in various predefined design environments, for example in an ECAD tool environment, an MCAD tool environment, or in a predefined PCB Parts library environment.

Collaboration interface 10 uses a collaboration format to perform the transfer of collaboration files to and from MCAD tool 20, ECAD tool 15 and collaboration interface 10. For example, the collaboration format may be an IDX (Interdomain Design Exchange) format for collaboration. IDX format is an XML-based messaging format defined for the purpose of exchanging PCB layout changes between MCAD tool 20 and ECAD tools 15. Collaboration files may be generated by either the collaboration PCB software on ECAD tool 15 or collaboration MCAD software on the MCAD tool 20 that is based on the IDX format. It should be noted that the IDX format is only one illustrative collaboration format, and that the present disclosure is not limited to this collaboration format, i.e., other collaboration formats may be implemented. In addition to the IDX data, collaboration files may contain collaboration status to facilitate exchange and improve usability. Users can also define a collaboration project folder which may include a sub-directory within collaboration folder 16 for a MCAD/ECAD collaboration of a specific board design and mechanical assembly. In one embodiment, any files (e.g., collaboration files, incremental collaborative files, etc.) stored in the collaboration folder are accessible by the ECAD tool 15 and/or the MCAD tool 20 via a push function or a pull function.

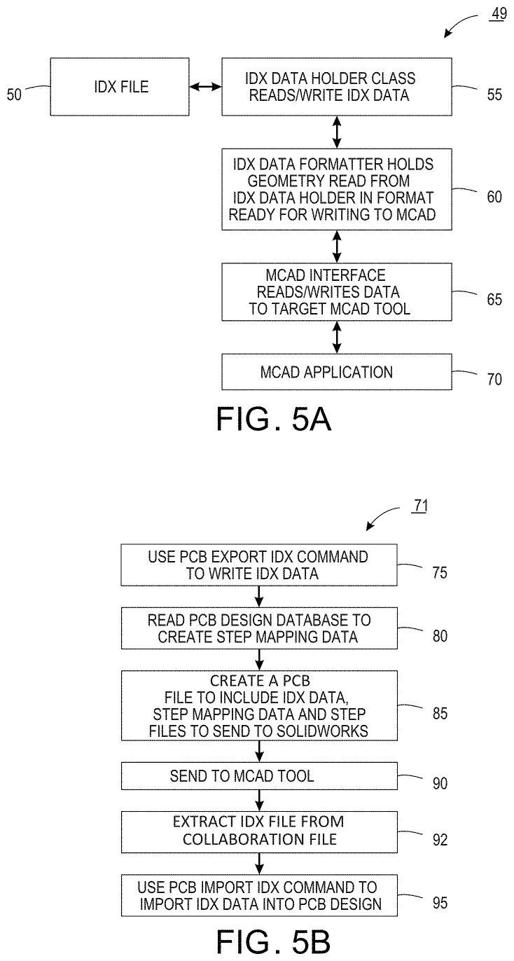

In one embodiment, the IDX format may allow the collaboration interface 10 to exchange data between the ECAD tool 15 and the MCAD tool 20 without reformatting into a particular format. FIGS. 5A and 5B illustrate example flow charts of how the collaboration interface 10 uses the IDX data.

FIG. 5A illustrates an example of flowchart of reading/writing of IDX data that is performed by the collaboration interface 10 when collaboration interface 10 is interfacing with the MCAD tool 20. The present embodiment utilizes the same code for Import, Export and Collaboration. At block 50, the method 49 starts with an IDX file. At block 55, the IDX Data Holder classes which Reads/write IDX data. In some embodiments, the IDX Data Holder class manages the reading and writing of the IDX XML. At block 60, the IDX Data Formatter holds geometry read from IDX data holder in a format ready for writing to the MCAD tool. In some embodiments, the Data Formatter class converts the IDX data into object lists holding data such as the board outline, component data, holes, keep ins and keep outs and conductors. The Data formatter generates, for example, a collaboration file having an “.emzs” file extension for the MCAD tool's contents to the collaboration folder 16. At block 65, in some embodiments, the collaboration interface 10 Reads/Writes data into the MCAD tool of MCAD application at block 70.

FIG. 5B illustrates an example flowchart on how collaboration interface 10 writes data into collaboration folder 16 to be exported into the MCAD tool 20. At block 75, in some embodiments, collaboration interface 10 uses PCB Export IDX Command to write IDX data. At block 80 of the method 71, the collaboration interface 10 reads from the PCB file data (broadly ECAD design data) stored in the database of the ECAD tool 15 to create block mapping data. In some embodiments, the PCB file data for integration with the MCAD tool 20 includes PCB file data in the IDX data format. In one embodiment, the PCB file data may optionally include external copper layers in IDX data format. In one embodiment, the PCB file data may include a Step model to package mapping data and includes all of the mapped Step files. At block 85, in some embodiments, collaboration interface 10 generates a collaboration file of a PCB file which includes IDX data, Step mapping data, and Step files that are then sent to the MCAD tool at block 90. Collaboration interface 10 exports the collaboration file to collaboration folder 16. Collaboration interface 10 generates, for example, an “.emzp” file extension for the collaboration files in collaboration folder 16 having content of the ECAD tool 15. It should be noted that the use of the “.emzp” and “.emzs” file extensions are only illustrative. Other unique extensions can be used as long as such file extensions are recognized by the collaboration interface 10 as collaboration files as discussed in the present disclosure.

Blocks 92 and 95 illustrate the process of reading data into the MCAD tool. In some embodiments, the collaboration interface 10 imports the IDX format data (including symbols and design layers) into the PCB design. At block 92, collaboration interface 10 may extract IDX file from collaboration file. At block 95, in some embodiments, collaboration interface 10 may use PCB Import IDX command to import IDX data into PCB design.

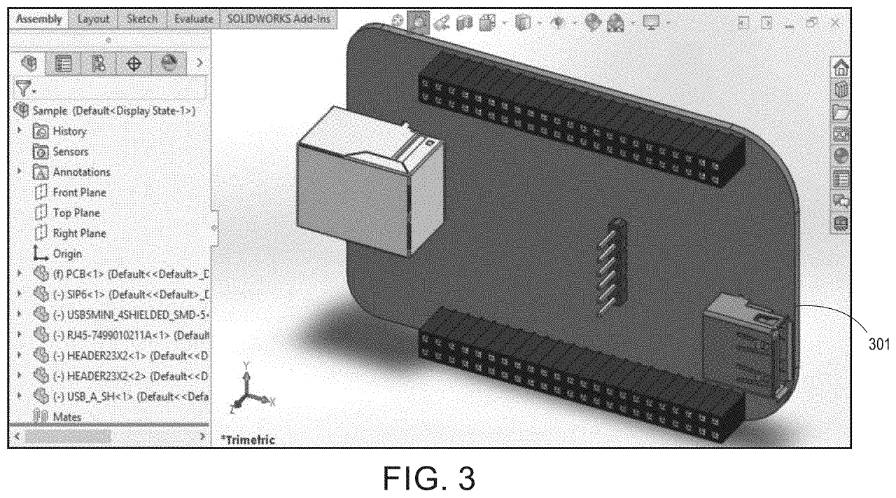

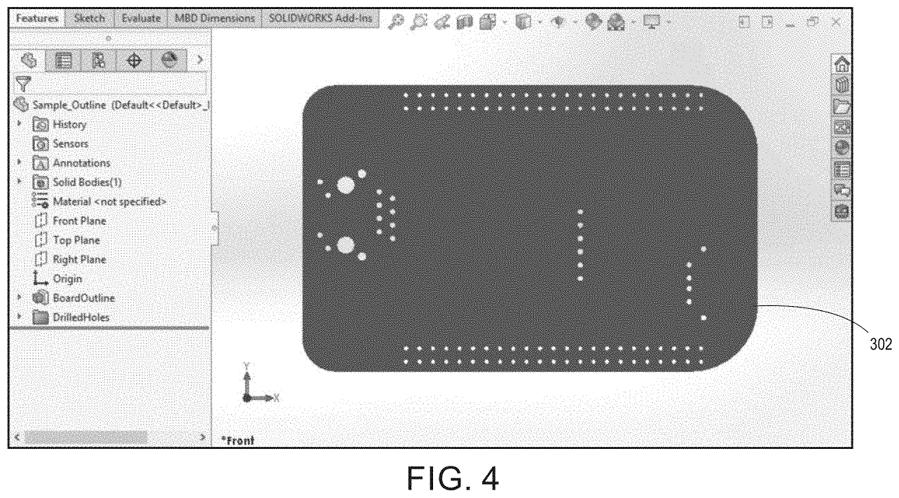

In one embodiment, the MCAD tool may be used to create a PCB, as discussed above. FIGS. 3 and 4 illustrate example screenshots of an assembly 301 and a board outline 302 built by a PCB export in the MCAD tool 20 in accordance with one embodiment of the present disclosure. Once assembly 301 and the board outline are exported, built, and displayed on the user interface (UI) of the MCAD tool 20, the MCAD designers may simulate and analyze PCB elements in the context of the mechanical assembly in the MCAD tool 20. The MCAD designers can view PCB board outlines and can make modifications to the board outline and PCB elements with PCB toolkit 5 which will be discussed infra.

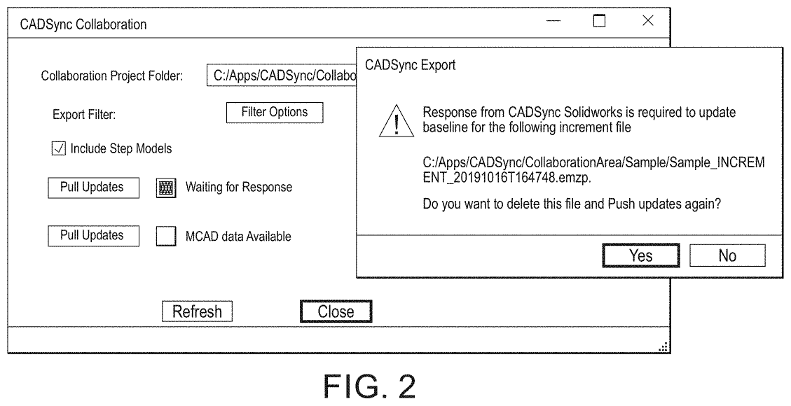

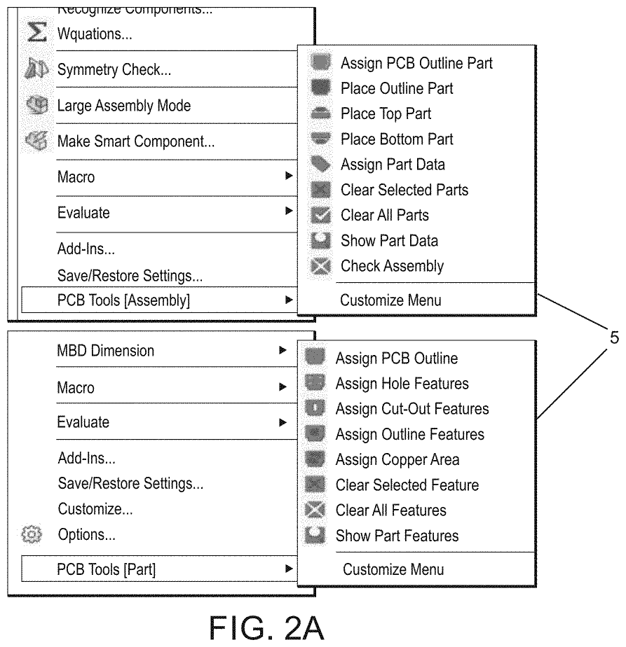

FIG. 2A illustrates an example screenshot of feature windows that can be shown on the UI of the MCAD tool 20. PCB toolkit 5 are ECAD tools typically associated with and used in ECAD environments. PCB toolkit 5 is generated by collaboration interface 10 onto the menu options of MCAD tool 20. PCB toolkit 5 utilizes MCAD specific dialog that is derived from Base dialog of the MCAD tool 20. PCB toolkit 5 utilizes MCAD tool's import/export interface which allows reading/writing of MCAD data during collaboration (e.g., as described in FIG. 5A and/or FIG. 5B above). The Base dialog provides access to common IDX collaboration functions such as Data Formatter and Data Holder classes to manage collaboration. The PCB toolkit 5 enables the MCAD designer to work on PCB features in their (native design or native format) MCAD tool environment and allows the MCAD designer to automatically capture the data needed to properly specify changes and requirements in the ECAD environments for ECAD designers. For example, PCB toolkit 5 may include tools for laying out a PCB, placing parts, routing, checking designs, and outputting production files. FIG. 2A provides some examples and should not be considered limiting. If a modification is made to the PCB assembly or board outline by the MCAD designer, for example, collaboration interface 10 may automatically generate the modification data. An example of the modification data may be an incremental collaboration file (or broadly referred to as an “increment file” or “incremental file”) which is sent to collaboration folder 16. For example, an incremental collaboration file may contain only information for objects that changed since the last push. Modification data may include a response file that may be created by collaboration interface 10, which contains the status of acceptance or rejection of changes pushed for a given incremental collaboration file. For example, the response file may be used to synchronize the assembly to the board file.

FIG. 2 illustrates an example screenshot of feature windows of a collaboration status notification. A designer can access various collaboration interface menu items and dialog boxes on the UI of the MCAD tool 20 and on the UI of the ECAD tool 15. Collaboration interface 10 provides an easy to use bidirectional interface that supports incremental updates between the MCAD tool 20 and the ECAD tool 15. The collaboration process may be initiated from a PCB design (broadly an ECAD assembly design) or an MCAD assembly design. After initiation, users may review on-going updates before applying updates by using a push or pull command. For example, Push Updates status may be illustrated on UI in dialogs boxes being in one of the following states:

Green—Ready to push updates to MCAD tool 20
Red—Recently push updates await processing by MCAD tool 20.
The Pull Updates status may be in one of the following states:
Green—No MCAD updates are available
Yellow—MCAD data is available and Pull Update button is enabled.

Having in mind the principle elements of the present disclosure as discussed supra, a better understanding of the operation of collaboration interface 10 can be had with the following discussion of the function and pseudocodes which are useful in automatically capturing modification data to revise the collaborative data files to design changes of assembly/part and to conform to operating requirements of the MCAD design environment or ECAD design environment. The function examples and the description thereof are illustrative below but not limited thereto those described:

STEP Models for design—Any associated STEP model to the associated footprint in the PCB Editor will be exported to the EMZP file in the collaboration folder to be automatically built as a MCAD part in the MCAD application.

STEP Mapping—This mapping may be required to relay the STEP model orientation and position to MCAD tool. Collaboration interface 10 uses this information to align and orient the model to the MCAD part being applied to the MCAD assembly.

Step Model Conversion to Parts

Open Step Model in MCAD tool
Check for rotations/offsets
If none, convert to Part

### Else

Place Part into new Part and apply offsets and rotations

### Save as new Part

Collaboration—Compare

Reads MCAD data into Data Formatter
Reads IDX baseline data into Data Formatter. This is used as the reference for changes
Data Formatter provides function to compare
Reports either No Changes or provides Information on changes that can be displayed in a grid

Collaboration—To PCB Mode

Use when changes to be sent from MCAD tool to PCB tool
Changes are held in data formatter, displayed in grid
Checked items data written to Incremental IDX file.
Program waits for a response from PCB that will contain information on whether changes were accepted.
If changes are Accepted, an internal “baseline” is updated by injecting changes into the changed items in Data Holder class—this is used for future compares.
This is effectively the state of the PCB and allows for continual compares during collaboration.
If changes are Rejected, the MCAD data can be reverted, using the internal baseline as it has not been updated.
For components that have holes, a function is invoked to update the co-ordinates of the component's holes. This give the user the option to move the holes to match their parent component.

Collaboration—from PCB Mode

Used when changes are sent from PCB tool to MCAD tool
When changes are made in PCB, an IDX Incremental file is created
When this is detected, a grid is populated with the changes
If the user checks a change, a preview is provided
The user can initiate a Pull that causes the checked changes to be written to MCAD tool.
A response IDX file is created to inform PCB which changes have been accepted. Also, this response information is used in MCAD to update the internal baseline with the accepted changes again by injected change data into the items in the Data Holder to be used for future compares.
The Incremental file sent from PCB contains information about component holes that have moved. This information is used to update internal baseline with the location of component holes that have moved, again by injecting change data into the Data Holder class.

Export/Import

Export functionality allows user to export a baseline into Project collaboration folder. User can choose to include copper layers and Step data.
Import functionality allows user to import a baseline into PCB design. Collaboration project folder will be set to the location of the baseline file.

Collaboration Framework

Collaboration dialog allows users to push/pull updates to/from a Collaboration project folder.
Push updates functionality creates an incremental IDX file with any new design changes. User can also choose to include copper layers and step data.
Pull Updates functionality imports incremental changes/response file into PCB design. Pull Updates status changes as new MCAD data becomes available.

### Collaboration—Push Updates

Uses PCB Export IDX command to push any new design changes into an incremental IDX file. Informs user when no changes are detected.
Writes an IDX file with external Copper layers if option is selected
Creates Step mapping file and includes step files if option is selected.
Push Updates status changes to “Waiting for response” until a response from MCAD is applied to PCB design.
While in “waiting for response” mode, if user pushes a new update, user will be prompted to override the last incremental file.
Collaboration—Pull updates
Pull Updates status changes to “MCAD Data available” when new incremental files/response files are found in Project collaboration folder.
Uses PCB Import IDX to import incremental file into PCB design. Writes a response file with Accepted/Rejected changes.
Uses PCB Import IDX to import response file into PCB design. Updates PCB baseline with accepted/rejected changes.

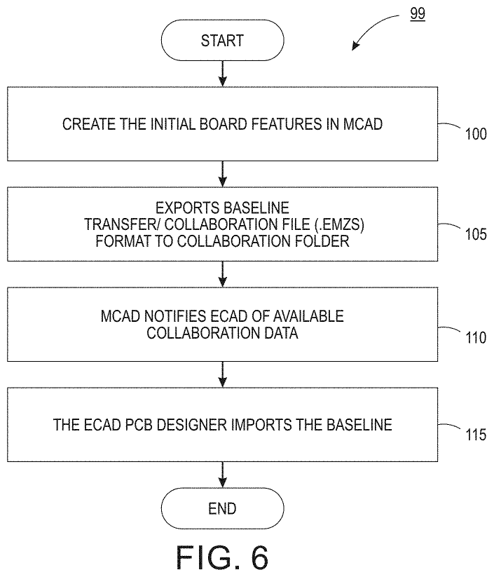

Having in mind the principle elements of the present disclosure as discussed supra, a better understanding can be had with the following example discussion of the MCAD/ECAD process flow in a collaborative design setting utilizing collaboration interface 10. FIG. 6 illustrates a flowchart of an example flowchart of method 99 where a design is initialized from an MCAD tool in accordance with one embodiment of the present disclosure. At block 100 of method 99, initial board features are created by the MCAD tool 20 using collaboration interface 10, e.g., PCB tools of the collaboration interface 10. For example, the method may receive a design file (e.g., an MCAD assembly design) in a first native format (e.g., an MCAD native format) from a first design tool (e.g., an MCAD tool). With these PCB tools, the board shape can be defined, important Keepins and Keepouts can be specified, and critical components such as connectors, switches, displays, and LEDs can be placed using a mechanical design system.

At block 105, the information from block 100 can be exported as a baseline file and converted to a collaboration file format (e.g., an .emzs file extension described above) and moved to the collaboration folder by the collaboration interface 10. For example, the method may modify the design file by embedding baseline data to create a collaboration file. For example, baseline data, e.g., IDX baseline data can be embedded directly into the MCAD assembly design. In one example, the .emzs file is the vehicle to include pertinent collaboration data in the correct format that the collaboration interface PCB tools require. In the initial Export will be a baseline file. A file naming technique is used to instruct the collaboration interface PCB tools on what specific type data is available in the collaboration folder. In this step for example, the .emzs file created by the collaboration interface 10 may contain the IDX baseline data and historical data. In one embodiment, the historical data (e.g., in an XML or ASCII format) may comprise revision data or tracking data associated with a particular design. For example, changes made by the MCAD tool and/or ECAD tool can be continuously tracked and stored in the historical data such that it will allow the collaboration interface 10 to track the design as it evolves over time. For example, the historical data will allow the collaboration interface 10 to show a user an earlier design from the current design, e.g., allowing the user to roll back some previously accepted changes. It should be noted that the inclusion of the historical data is an optional feature. This feature will allow the user to quickly recall and view an earlier design. Also, the collaboration interface will write/embed the IDX data into the current MCAD assembly design or ECAD assembly design. This is necessary to be used in any future collaboration techniques for comparing changes. More specifically, the collaboration interface 10 will embed all of the necessary baseline data (e.g., baseline data in an IDX format) into a first CAD assembly design (e.g., an MCAD assembly design or an ECAD assembly design) created in a first CAD environment (e.g., an MCAD tool or an ECAD tool) so that it can be rendered automatically in a second CAD environment (e.g., an MCAD tool or an ECAD tool) via the collaboration interface 10.

At block 110, collaboration interface 10 generates a notification that collaboration data is available. In one example, the collaboration interface relays the availability of collaboration data from the MCAD system to the ECAD system via an automatic email notification. This action improves the workflow to ensure notification occurs. In one example, the method presents the collaboration file to a second design tool (e.g., an ECAD tool) operating in a second native format (e.g., an ECAD native format).

At block 115, the PCB designer via the ECAD system imports the collaboration file via collaboration interface 10 to use as the basis for the board layout in the PCB layout system. After placing the remaining components, the fully placed board assembly is passed back through the collaboration exchange format to the MCAD system to verify that the board assembly fits into the final product package. Multiple iterations of the method 99 may occur during the product design phase until the end of design phase.

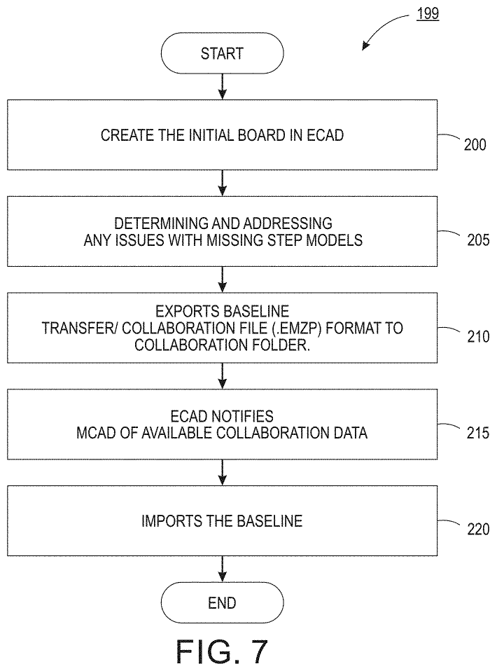

FIG. 7 illustrates an example flowchart of a method 199 that is initialized from an ECAD tool in accordance with one embodiment of the present disclosure. At block 200 of method 199, the board shape is defined and critical components can be placed. The critical components may include components such as connectors, switches, displays, and LEDs onto the board file. For example, the method may receive a design file (e.g., an ECAD assembly design) in a first native format (e.g., an ECAD native format) from a first design tool (e.g., an ECAD tool). At block 205, any issues with missing STEP models in the ECAD environment can be determined and addressed, if necessary. For example, the method may modify the design file by embedding baseline data to create a collaboration file. For example, baseline data, e.g., IDX baseline data can be embedded directly into the ECAD assembly design.

At block 210, the collaboration interface converts a baseline board file with STEP model information and other mechanical information into a collaboration file in a (.emzp) format and the collaboration file is stored in a collaboration folder. For example, the .emzp file produced from the collaboration interface in this step is to collectively add all required 3D models (STEP), any mapping/orientation-rotational information of the 3D Models which is an ASCII text-based format and history data. For example, the collaboration interface will also write/embed the IDX data to be exported in the Allegro PCB Editor .BRD file at this step.

At block 215, ECAD tool, via collaboration interface 10, notifies the MCAD tool of the available collaboration data. In one example, the collaboration interface relays the availability of collaboration data from the ECAD system to the MCAD system via an automatic email notification. This action improves the workflow to ensure notification occurs. In one example, the method presents the collaboration file to a second design tool (e.g., an MCAD tool) operating in a second native format (e.g., an MCAD native format).

At block 220, the collaborate file can be imported using the collaboration interface wherein the collaboration interface automatically creates an assembly in the MCAD tool or reuse if available in the MCAD library from the imported STEP model. For example, an MCAD user via the collaboration interface may open and selects this .emzp file in the collaboration folder to build the ECAD representation at this point. As the design progresses, updates to the mechanical information via collaboration interface 10 is pushed and pulled between the designers collaboratively until the design is complete at the end.

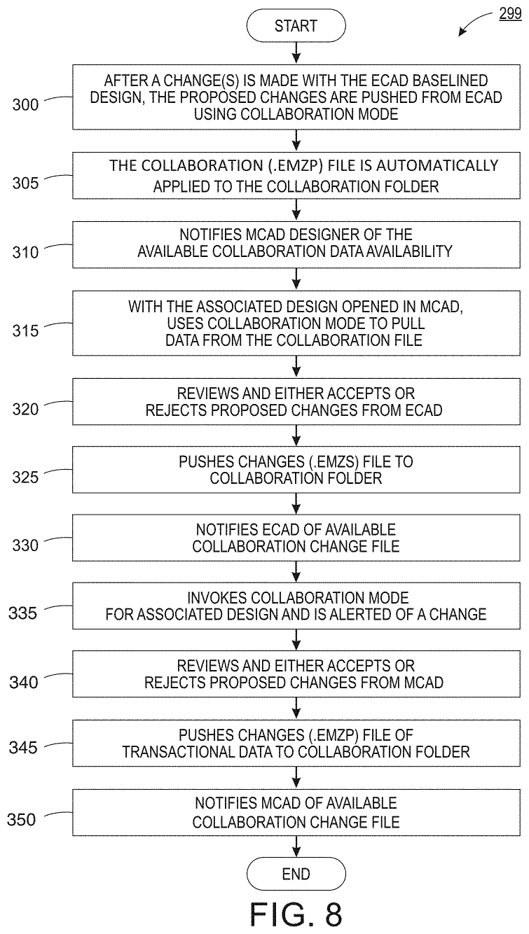

FIG. 8 illustrates an example flowchart of a method 299 for a design change that is initialized from the ECAD tool in the collaboration flow in accordance with one embodiment of the present disclosure. At block 300 of method 299, after a change(s) is/are made with the ECAD baselined design, the proposed changes are pushed from ECAD tool using a collaboration mode of the collaboration interface. At block 305, the collaboration (.emzp) file is automatically applied to the collaboration folder. In one embodiment, this .emzp file is a similar structure as outlined in step 210 of FIG. 7. One difference is that an incremental based IDX file (broadly containing just the changes (e.g., modification of a component, deletion of a component and/or addition of a component) that have occurred from a previous version) is contained here instructing which changes need to occur from the ECAD tool to the MCAD tool. For example, the .emzp file's file name is adjusted to instruct the collaboration interface in the MCAD tool on the current collaboration state (e.g., the file naming can be implemented to indicate different versions or iterations, e.g., version 1, version 2, etc. or date 1, date 2, etc.).

At block 310, via collaboration interface, the ECAD tool notifies MCAD tool of the available collaboration data availability. In one example, the collaboration interface relays the availability of collaboration data from the ECAD tool to the MCAD tool via an automatic email notification. This action improves the workflow to ensure notification occurs.

At block 315, with the associated design opened in the MCAD tool, the MCAD tool, via the collaboration interface, uses a collaboration mode to pull data from the collaboration file.

At block 320, an MCAD Designer may review and either accepts or rejects proposed changes received from the ECAD tool.

At block 325, via the collaboration interface, the MCAD tool pushes changes, e.g., an (.emzs) file, to the collaboration folder. Like the .emzp file, this step takes any existing changes and relay them to the IDX file contained in the .emzs file which is then placed into the collaboration folder. The collaboration interface of the MCAD tool builds any pertinent information in the file name to keep alignment with the design data in the ECAD tool. This allows a way to easily select the proper incremental data from the MCAD tool.

At block 330, via the collaboration interface, the method notifies the ECAD tool of available collaboration change file. In one example, the collaboration interface relays the availability of collaboration data from the MCAD tool to the ECAD tool via an automatic email notification. This action improves the workflow to ensure notification occurs.

At block 335, ECAD tool, via collaboration interface, invokes a collaboration mode for the associated design and is alerted of a change.

At block 340, an ECAD Designer via the collaboration interface may review and either accepts or rejects proposed changes from the MCAD tool.

At block 345, the ECAD tool, via collaboration interface, pushes changes, e.g., an (.emzp) file of transactional data, to the collaboration folder. As in step 305, this .emzp file has the same structure for any changes as stated previously. Again, one difference here is that the IDX file contained in the collaboration file is being processed to address new transactional changes between the two design systems. This is identified in the file name and embedded in the IDX file.

At block 350, ECAD tool, via collaboration interface, notifies MCAD of available collaboration change file. In one example, the collaboration interface again relays the availability of collaboration data from the ECAD tool to the MCAD tool via an automatic email notification.

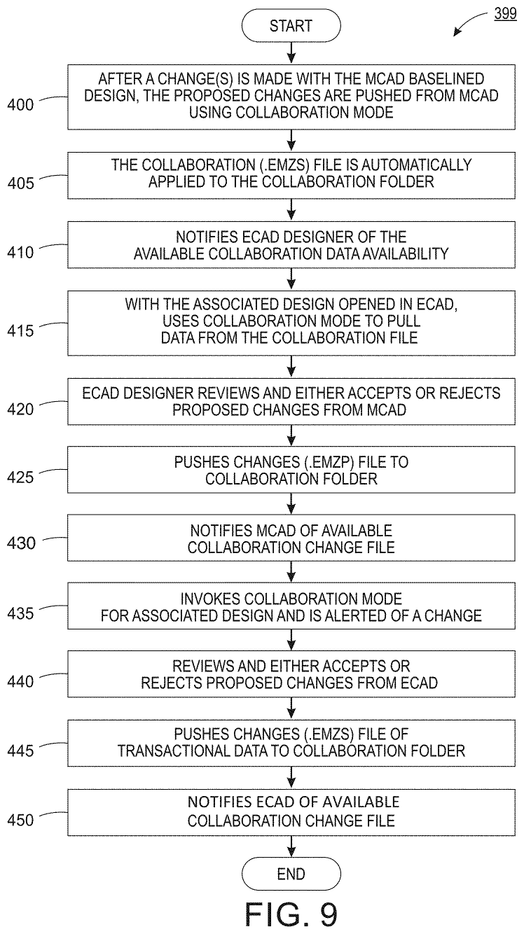

FIG. 9 illustrates an example flowchart of a design change that is initialized from the MCAD tool in the collaboration flow accordance with one embodiment of the present disclosure. At block 400 of the method 399, after a change(s) is made with the MCAD baselined design, the proposed changes are pushed from MCAD using a collaboration mode of the collaboration interface. At block 405, the collaboration (.emzs) file is automatically applied to the collaboration folder. At block 410, the MCAD tool, via collaboration interface, notifies ECAD tool of the available collaboration data availability. At block 415, with the associated design opened in ECAD, the ECAD tool, via collaboration interface, uses collaboration mode to pull data from the collaboration file (e.g., sending a request for the collaboration file). At block 420, ECAD Designer reviews and either accepts or rejects proposed changes from MCAD. At block 425 ECAD tool, via collaboration interface, pushes changes (.emzp) file to collaboration folder. At block 430, ECAD tool, via collaboration interface, notifies MCAD of available collaboration change file. At block 435, MCAD tool, via collaboration interface, invokes collaboration mode for associated design and is alerted of a change. At block 440, MCAD Designer reviews and either accepts or rejects proposed changes from ECAD. At block 445, MCAD tool, via collaboration interface, pushes changes (.emzs) file of transactional data to collaboration folder. At block 450, MCAD tool, via collaboration interface, notifies the ECAD tool of available collaboration change file.

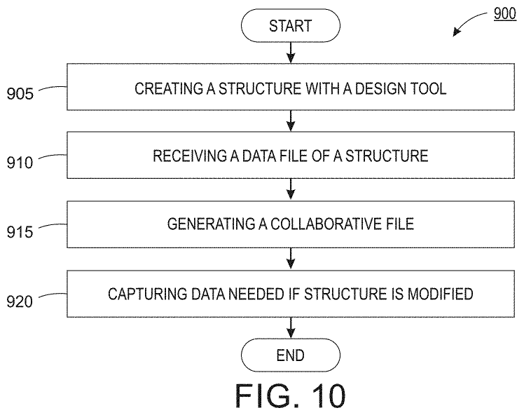

FIG. 10 illustrates a flowchart showing an example of a collaboration method 900 for designing and creating electronic structures and mechanical systems in a first predefined design environment (e.g., an MCAD or ECAD environment) and a second predefined design environment (e.g., an MCAD or ECAD environment) according to various embodiments of the present disclosure.

At block 905 of method 900, structures are created in a first predefined design environment with a first design tool. In some embodiments, a MCAD designer can create on PCB features in their (e.g., in a native CAD format) MCAD design environment.

At block 910, a processor receives data file being representative of the structure created in the second predefined design environment, the data file having a first predefined data format. In some embodiments, received data files may include PCB file data which may optionally include external copper layers in IDX data format.

At block 915, a collaborative data file is generated having a collaborative data format derived from the data file being representative of the structure. In some embodiments, the processor generates an .emzp file extension and/or .emzs file extension for the collaboration files. At either the ECAD tool or the MCAD tool, processes at this step are controlled by the collaboration interface 10 creating one or more collaborative files. In one embodiment, during this process, the user is guided through the changes via the collaboration interface 10 giving visual aids to assist the user in determining the action required for the change. For example, a preview of the changes can be provided at this step, thereby providing the user with a mechanism to determine whether an acceptance or a rejection of the relayed changes (e.g., proposed changes) from either ECAD tool or the MCAD tool respectively, should be implemented.

At block 920, the processor can automatically capture data needed for specific changes and requirements in the second predefined design environment when the structure is modified in the first predefined design environment. In some embodiments, when a modification is made to the PCB assembly or board outline by the MCAD designer, for example, the processor may automatically generate modification data. An example of the modification data may be an incremental collaboration file which is sent to collaboration folder 16.

In summary, there has been provided a collaboration interface for an automation design system. The collaboration interface provides PCB designers and MCAD designers in-tool access to native CAD data structures for maximum performance, efficiency, and accuracy. The collaboration interface includes a PCB toolkit for a MCAD tool which enables MCAD designer to work on PCB features in their native design environment, while automatically capturing the data needed to properly specify changes and requirements in the ECAD environment or MCAD environment.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the methods discussed above can be used to configure a hardware processor to perform the steps, functions and/or operations of the above disclosed methods. In one example, instructions and data for the present module or process for facilitating the exchange of design data between an MCAD tool and an ECAD tool can be loaded into a memory 11 and executed by hardware processor element 9 to implement the steps, functions, or operations as discussed above in connection with the various illustrative methods discussed above. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module or process for facilitating the exchange of design data between an MCAD tool and an ECAD tool of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

In other words, the foregoing description of embodiments of the present disclosure has been presented for purposes of illustration and description only. It is not intended to be exhaustive or to limit the disclosure to the forms disclosed. Obviously, many modifications and variations will be apparent to practitioners skilled in the art.

We claim:

1. A method comprising:
receiving, by a processor, a design file in a first native format from a first design tool;
modifying, by the processor via a collaboration interface, the design file by embedding baseline data to create a collaboration file; and
presenting, by the processor, the collaboration file to a second design tool operating in a second native format.

2. The method of claim 1, wherein the design file in the first native format comprises a mechanical computer-aided design assembly design, and wherein the first design tool comprises a mechanical computer-aided design tool.

3. The method of claim 2, wherein the second design tool comprises an electronic computer-aided design tool.

4. The method of claim 3, further comprising:
generating an incremental collaborative file comprising at least one change when the mechanical computer-aided design assembly design is modified.

5. The method of claim 4, further comprising:
transmitting a notification of a presence of the incremental collaborative file to the second design tool.

6. The method of claim 5, wherein the notification includes the incremental collaborative file.

7. The method of claim 5, wherein the incremental collaborative file is pulled by the second design tool.

8. The method of claim 4, wherein the collaboration interface presents the at least one change in the second native format to allow the electronic computer-aided design tool to modify the mechanical computer-aided design assembly in accordance with the at least one change.

9. The method of claim 1, wherein the design file in the first native format comprises an electronic computer-aided design assembly design, and wherein the first design tool comprises an electronic computer-aided design tool.

10. The method of claim 9, wherein the second design tool comprises a mechanical computer-aided design tool.

11. The method of claim 9, further comprising:
generating an incremental collaborative file comprising at least one change when the electronic computer-aided design assembly design is modified.

12. The method of claim 11, further comprising:
transmitting a notification of a presence of the incremental collaborative file to the second design tool.

13. The method of claim 12, wherein the notification includes the incremental collaborative file.

14. The method of claim 12, wherein the incremental collaborative file is pulled by the second design tool.

15. The method of claim 11, wherein the collaboration interface presents the at least one change in the second native format to allow the mechanical computer-aided design tool to modify the electronic computer-aided design assembly in accordance with the at least one change.

16. The method of claim 1, further comprising:
storing the collaboration file in a collaboration folder that is accessible by both the first design tool and the second design tool.

17. The method of claim 1, wherein the baseline data is formatted in a collaboration format.

18. The method of claim 17, wherein the collaboration format comprises an Interdomain Design Exchange format.

19. A device comprising:
a processing system including at least one processor; and
a computer-readable medium storing instructions which, when executed by the processing system, cause the processing system to perform operations, the operations comprising:
receiving a design file in a first native format from a first design tool;
modifying via a collaboration interface the design file by embedding baseline data to create a collaboration file; and
presenting the collaboration file to a second design tool operating in a second native format.

20. A non-transitory computer-readable medium storing instructions which, when executed by a processor, cause the processor to perform operations, the operations comprising:
receiving a design file in a first native format from a first design tool;
modifying via a collaboration interface the design file by embedding baseline data to create a collaboration file; and
presenting the collaboration file to a second design tool operating in a second native format.
